(19) United States
(12) Patent Application Publication
(10) Pub. No.: US 2018/0262631 A1
(43) Pub. Date: Sep. 13, 2018

(54) IMAGE FORMING DEVICE AND NON-TRANSITORY RECORDING MEDIUM

(71) Applicant: KONICA MINOLTA, INC., Tokyo (JP)

(72) Inventor: Masaki Nakata, Toyohashi-shi (JP)

(73) Assignee: KONICA MINOLTA, INC., Tokyo (JP)

(21) Appl. No.: 15/904,240

(22) Filed: Feb. 23, 2018

(30) Foreign Application Priority Data
Mar. 7, 2017 (JP) 2017-042433

(51) Int. Cl. H04N 1/00

(52) U.S. Cl. CPC H04N 1/00132; H04N 1/00071; H04N 1/00074; H04N 1/00007; H04N 1/00037; H04N 1/00925

(57) ABSTRACT

An image forming device, includes: a body that processes a print job and discharges a printing sheet; a post-processing device that may be connected or detached from the body, and a hardware processor. The hardware processor performs: determining whether or not a sheet type indicated by the print job may be post-processed by the post-processing device; guiding a user to detach the post-processing device from the body when the sheet type indicated by the print job may not be post-processed by the post-processing device; detecting a distance between the post-processing device and the body when the post-processing device is detached from the body; and allowing a processing of print job when the detected distance is greater than an interval that enables the processing of the print job if the sheet type indicated by the print job may not be post-processed by the post-processing device.

The entire disclosure of Japanese patent application No. 2017-042433, filed on Mar. 7, 2017, is incorporated herein by reference in its entirety.

### BACKGROUND

### Technological Field

The present invention relates to an image forming device and a non-transitory recording medium. The present invention more specifically relates to a technique for processing a job, with an image forming device provided with a post-processing device as a finisher, which cannot be processed by the post-processing device.

### Description of the Related Art

An image forming device with a post-processing device for a non-long paper such as a fixed size paper is capable of printing even a long paper which cannot be conveyed by the post-processing device. This known technique is introduced for example in Japanese Patent Application Laid-Open No. JP 2006-248635 A (hereafter, document 1). The image forming device has the post-processing device which is movable between a first set position to receive a long paper discharged by the image forming device body and a second set position to receive a non-long paper. The post-processing device may be in the second set position. A sheet discharge opening of the body and a sheet lead-in opening of the post-processing device are then close to and opposite to. The printing sheet discharged by the body enters inside the post-processing device, and a post-processing is performed. The post-processing device may be in the first set position. The long paper discharged by the sheet discharge opening of the body is guided toward an upper surface of the post-processing device. The long paper thus does not enter inside the post-processing device, and is discharged to the upper surface of the post-processing device.

As the body of the image forming device, there are reasonable bodies for general office works and expensive bodies for professional-quality printings. Recently, the device that may be used for both of the general office works and the professional-quality printings is provided as that intermediate between the body for general office works and the body for professional-quality printings. Sheets supported by such intermediate body are the same as those supported by the expensive body for professional-quality printings. Specifically, more types of sheets are supported by the intermediate body than the reasonable body for general office works. Sheets that cannot be passed through the body for general office works including, for example, a sheet of a large size such as a sheet of 13 inch×19 inch, an embossed paper, a thick paper and a thin paper may be passed through the intermediate body, and the intermediate body may perform printing with such sheet.

The post-processing device for general office works may be connected to the aforementioned intermediate body. A problem such as some sheets may be passed through the body but not the post-processing device then may occur. In order to resolve the problem, as according to the above-described known technique, the post-processing device may be temporarily detached from the body. The printing sheet discharged by the body is enabled to be discharged to the upper surface of the post-processing device without being entered inside the post-processing device.

The conventional image forming device is capable of finding the position of the post-processing device if the post-processing device is in either the first or the second set position. The post-processing device may be in the position except for the first or the second set position. The image forming device then is not capable of finding the position of the post-processing device. When a user would like to enable printing using the long paper which cannot be conveyed by the post-processing device, he or she is required to move the post-processing device to the first set position from the second set position every time. Specifically, the conventional image forming device is not allowed to process a print job using the long paper unless the post-processing device is moved to the first set position. It is a big burden on the user to detach the post-processing device from the body.

There may be as obstacle such as a desk and/or a cabinet at a destination where the user would like so move the post-processing device to. It is difficult for the user to move the post-processing device to the first set position. The conventional image forming device does not process the print job then. The sheets not supported by the post-processing device are not printed in the conventional image forming device.

### SUMMARY

The present invention is intended to solve the above problems. Thus, the present invention is intended to provide an image forming device and a non-transitory recording medium capable of performing printing on a sheets not supported by a post-processing device with a little burden on a user.

First, the present invention is directed to an image forming device, comprising: a body that processes a print job and discharges a printing sheet; a post-processing device, which may be connected or detached from said body, capable of receiving the printing sheet discharged by said body when being connected to said body and performing a post-processing; and a hardware processor.

To achieve at least one of the abovementioned objects, according to an aspect of the present invention, the image forming device reflecting one aspect of the present invention comprises the hardware processor that performs: determining whether or not a sheet type indicated by said print job may be post-processed by said post-processing device; guiding a user to detach said post-processing device from said body when the sheet type indicated by said print job may not be post-processed by said post-processing device; detecting a distance between said post-processing device and said body when said post-processing device is detached from said body; and allowing a processing of said print job when the detected distance is greater than an interval that enables the processing of said print job if the sheet type indicated by said print job may not be post-processed by said post-processing device.

Second, the present invention is directed to a non-transitory recording medium storing a computer readable program to be executed by an image forming device comprising: a body that processes a print job and discharges a printing sheet; and a post-processing device, which may be connected or detached from said body, capable of receiving the printing sheet discharged by said body when being connected to said body and performing a post-processing.

To achieve at least one of the abovementioned objects, according to an aspect of the present invention, the non-transitory recording mediums reflecting one aspect of the present invention stores the computer readable program, execution of the computer readable program by the image forming device causing said image forming device to perform; determining whether or not a sheet type indicated by said print job may be post-processed by said post-processing device; guiding a user to detach said post-processing device from said body when the sheet type indicated by said prior job may not be post-processed by said post-processing device;

detecting a distance between said post-processing device and said body when said post-processing device is detached from said body; and allowing a processing of said print job when the detected distance is greater than an interval that enables the processing of said print job if the sheet type indicated by said print job may not be post-processed by said post-processing device.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of an image forming device with a post-processing device connected to a body;

FIG. 2 illustrates an example of the post-processing device detached from the body;

FIGS. 3A and 3B illustrate exemplary configurations of a guide rail, a distance measurement sensor and a lock mechanism;

FIG. 4 illustrates a block diagram showing an example of an electronical structure of the image forming device;

FIGS. 5A and 5B illustrate examples where discharging an easily bendable sheet and a hardly bending sheet;

FIG. 6 illustrates a flow diagram explaining exemplary procures of a process performed by the image forming device;

FIG. 7 illustrates a flow diagram explaining an exemplary procedure of a job processing determination in detail;

FIG. 8 illustrates an example of a guidance screen including a message requesting to connect the post-processing device to the body;

FIG. 9 illustrates as example of a warning screen including a message indicating the post-processing may not be performed;

FIG. 10 illustrates an example of a guidance screen including a message requesting to detach the post-processing device from the body; and

FIG. 11 illustrates an example of a notification screen including a message notifying that a distance enables a processing a print job.

### DETAILED DESCRIPTION OF EMBODIMENTS

Hereinafter, one or more embodiments of the present invention will be described with reference to the drawings. However, the scope of the invention is not limited to the disclosed embodiments.

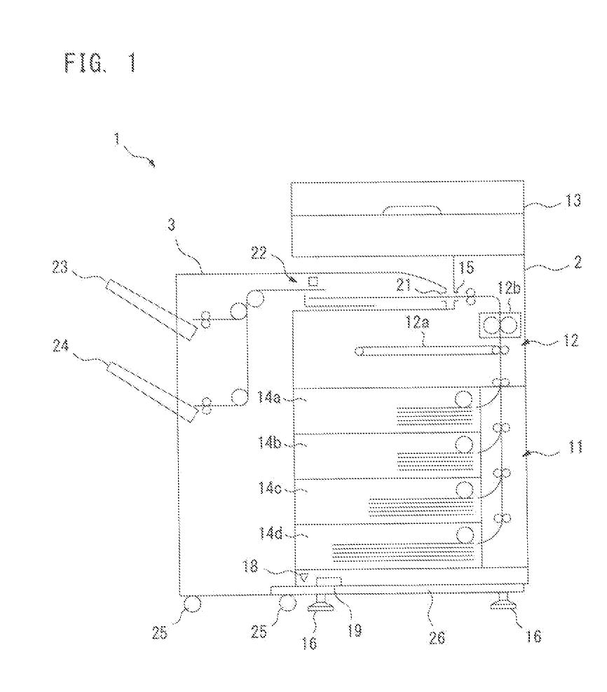

FIG. 1 illustrates an exemplary conceptual configuration of an image forming device 1 in which the present preferred embodiment of the present invention may be practiced. The image forming device 1 performs printing by processing a print job specified by a user. The image forming device is provided with a body 2 and a post-processing device 3, The post-processing device 3 is a device also called as a finisher.

The body 2 may be a MFP (Multifunction Peripherals), for instance. The body 2 is capable of printing on a variety of sheets including not only a regular sheet of a fixed size but also sheets those cannot be passed through a dedicated general office use device such as a big sheet of 13 inch×19 inch, an embossed paper, a thick paper or a thin paper. This is for the body 2 to be used not only the general office use but also professional-quality printings. As a structure to process the print job, the body 2 includes a feeder 11 and set image forming unit 12 herein. The body of the present preferred embodiment is capable of processing a scan job, for example, besides the print job. The body 2 has an image reading unit 13 in its upper part. The image reading unit 13 optically reads images of a document and constructs image data.

The feeder 11 may pick up a sheet placed in each of multiple sheet feeding cassettes 14a, 14b, 14c and 14d one after another to feed it to the image forming unit 12. The sheet may be placed on a manual paper feeder, which is not shown in FIG. 1. The sheet on the manual paper feeder may also be fed to the image forming unit 12. Different types of sheets may be stocked in the multiple sheet feeding cassettes 14a, 14b, 14c and 14d. Examples of the sheets that may be stocked in the cassettes are not only regular sheets of regular size but also the aforementioned sheets that cannot be passed through the dedicated general office use device. The sheets that cannot be passed through the dedicated general office use device may be fed from the manual paper feeder.

The image forming unit 12 forms a toner image on an intermediate transfer belt 12a based on the image data included in the print job. The toner image is transferred on the sheet at the time the sheet fed by the feeder 11 gets in contact with the intermediate transfer belt 12a. When the sheet with the transferred toner image passes through a fixing part 12b, the toner image is fixed to the sheet. The intake forming unit 12 discharges the printing sheet with the fixed toner image through a discharge port 15.

The body 2 is installed with grounding legs 16 on a ground surface. The body 2 thus does not move from the installation position.

The post-processing device 3 is installed beside the body 2. The post-processing device 3 receives the printing sheet discharged by the body 2, and performs the post-processing. Examples of the post-processing may be a processing to drive staples into multiple pages of printing sheets to bind the sheets, a punching to punch a predetermined position of the printing sheet and a center folding, processing to fold the printing sheet at a predetermined position. The post-processing device 3 receives the printing sheet from a sheet lead opening 21, and processes the post-processing specified in advance with the printing sheet with a post-processing media 22 installed inside. The post-processing device 3 discharges the post processed printing sheet to discharge trays 23 and 24. The post-processing setting may not be configured with the print job. The post-processing device 3 then may discharge the printing sheet to the discharge trays 23 and 24 by just passing through the sheet without performing the post-processing to the printing sheet received from the body 2.

The post-processing device 3 as described above is used for general office works, for example. The post-processing device 3 may not pass through a special sheet used for the professional-quality printings normally. More specifically, the post-processing device 3 is not capable of transferring normally sheets that may be discharged by the body 2 such as a sheet of large size, an embossed paper, a thick paper and a thin paper with a transfer path.

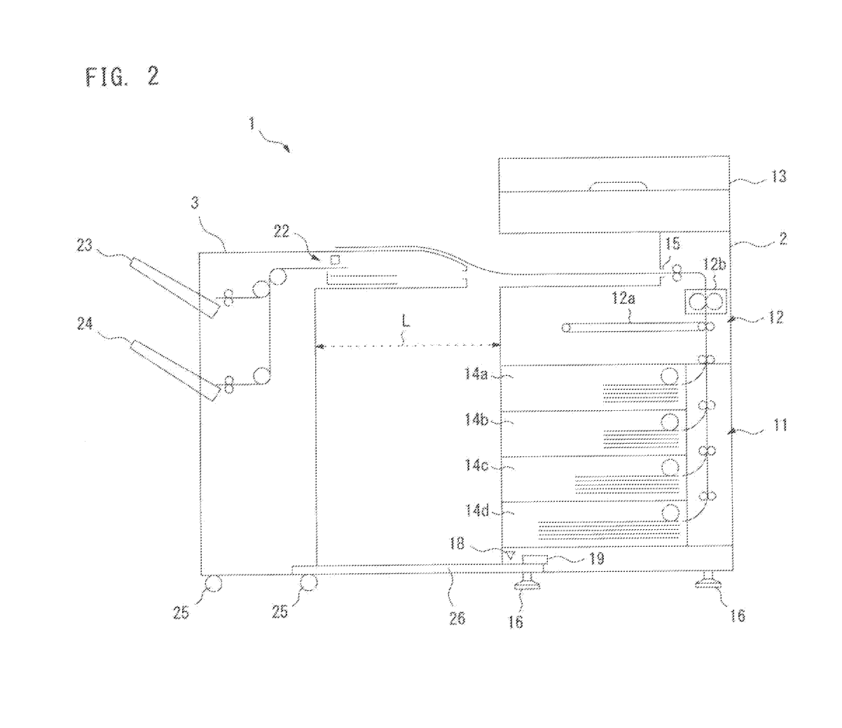

The post-processing device 3 of the present preferred embodiment has wheels 25 in its lower part so that it is allowed to be connected or detached from the body 2. The post-processing device 3 is installed on the ground via the wheels 25. An operator may move the post-processing device 3. The post-processing device 3 may be installed connecting to the body 2 or detached from the body 2. FIG. 1 illustrates the post-processing device 3 connected to the body 2. FIG. 2 illustrates an example of the post-processing device 3 detached from the body 2.

The post-processing device 3 is provided with a guide rail 26 in its lower part. An end of the guide rail 26 is connected to the lower part of the body 2 so that the slide of the post-processing device 3 is enabled. The post-processing device 3 is moved liner in the extension direction of the guide rail 26 (the normal direction with respect to the surface of body). The post-processing device 3 may be detached from the body 2 for the length of the guide rail 26. p Once the post-processing device 3 is moved to the position where it gets in contact with the side of she body 2 as shown in FIG. 1, it is connected to the body 2. Use post-processing device 3 then may receive the printing sheet discharged by the body 2 to process the post-processing. Specifically, once the post-processing device 3 is connected to the body 2, the sheet lead opening 21 to the post-processing device 3 and the discharge port 15 of the body 2 are close to and opposite from each other. The printing sheet discharged by the discharge port 15 of the body 2 is directly led in the transfer path inside the post-processing device 3.

Once the post-processing device 3 is detached from the body 2 as shows FIG. 2, on the other hand, the sheet lead opening 21 is detached from the discharge port 15 of the body 2. The printing sheet discharged by the body 2 is not led in the transfer path inside the post-processing device 3. The printing sheet is guided to the side of the upper surface of the post-processing device 3 with a guide member which is not shown in FIG. 2. A pubic known media, for instance, a media recited in the document 1 may be applied for the guide member which guides the printing sheet discharged by the body 2 to the side of the upper surface of the post-processing device 3.

The image forming device 1 may process the print job using the sheet not supported by the post-processing device 3. If the post-processing device 3 is detached from the body 2 then, the printing sheet may be discharged on the side of the upper surface of the post-processing device 3 without passing inside the post-processing device 3.

In order to appropriately discharge the sheet discharged by the body 2 on the side of the upper surface of the post-processing device 3, it is necessary for the user to detach the post-processing device 3 from the body 2 in accordance with the sheet type. In other words, if a distance L between the post-processing device 3 and the body 2 is appropriate for discharging the sheet indicated by the print job on the side of the upper surface of the post-processing device 3. It is not necessary for the post-processing device 3 to become distant from the body 2. A distance measurement sensor 18 is arranged nearby the guide rail 26, which is siding in the tower part of the body 2 of the present preferred embodiment. The distance measurement sensor 18 measures the distance between the post-processing device 3 and the body 2. Together with the distance measurement sensor 18, a lock mechanism 19 is also arranged. The lock mechanism 19 locks not to slide the guide rail 26.

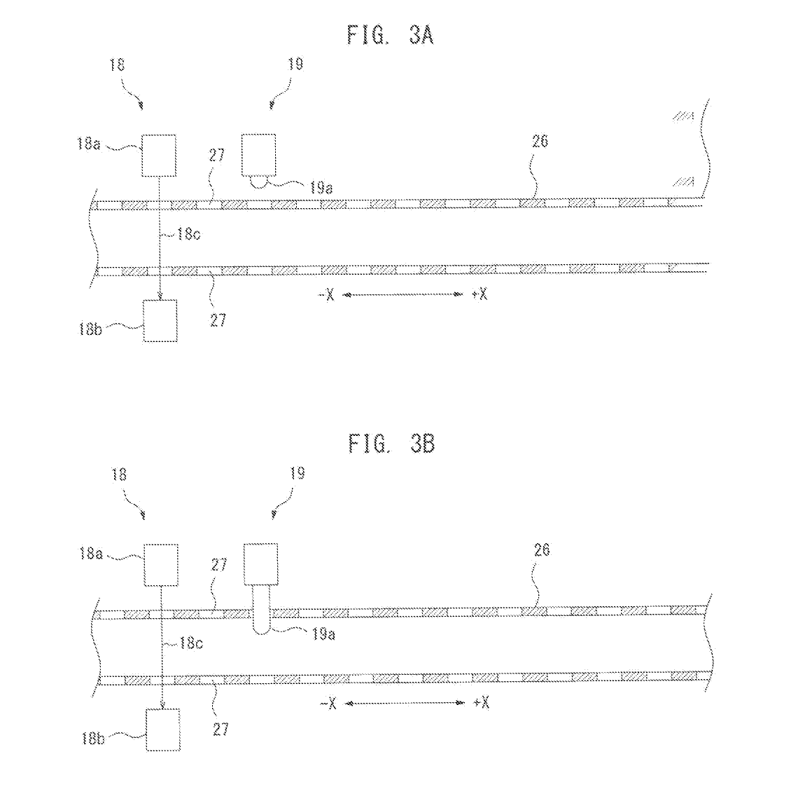

FIGS. 3A and 3B illustrate exemplary configurations of the guide rail 26, the distance measurement sensor 18 and the lock mechanism 19. The guide rail 26 is formed by a C type metallic rail, for instance. As illustrated in FIG. 3A, holes 27 are formed in flanges, each of which is opposite from each other. The holes are equally spaced, for example, at predetermined intervals (few centimeters). The distance measurement sensor 18 includes a lighting part 18a and a light receiver 18b. The lighting part 18a and the light receiver 18b are arranged between the flanges, for instance. A light 18c emitted by the lighting part 18a passes through the hole 27, and the light 18c is received by the light receiver 18b. If the light 18c emitted by the lighting part 18a is blocked by the flange, the light receiver 18b does not receive the light 18c. The distance measurement sensor 18 counts the number of the times that the light receiver 18b receives the light 18c, thereby measuring the distance between the post-processing device 3 and the body 2. Multiple pairs of the lighting part 18a and the light receiver 18b are arranged so that the sliding direction of the guide rail 26 (+x direction or −x direction) may also be detected. The distance measurement sensor 13 may measure the distance between the post-processing device 3 and the body 2 in a different way.

Upon an activation of an actuator, the lock mechanism 19 enables a rest piece 19a to protrude from and retract into the flange. The rest piece 19a is formed smaller than a diameter of the hole 27 formed in the flange. When the rest piece 19a is separated from the flange as illustrated in FIG. 3A, the slide of the guide rail 26 is enabled in +direction or −x direction associated with the move of the post-processing device 3. If the rest piece 19a is projected into the flange, the rest piece 19a is inserted into the hole 27 of the flange, as illustrated in FIG. 3B. The rest piece 19a is engaged with the hole 27 of the flange so that the slide of the guide rail 26 is not enabled in +x direction or −x direction. The guide rail 26 is locked with the lock mechanism 19. Once the guide rail 26 is locked, the post-processing device 3 may not be moved. The distance between the post-processing device 3 and the body 2 is fixed.

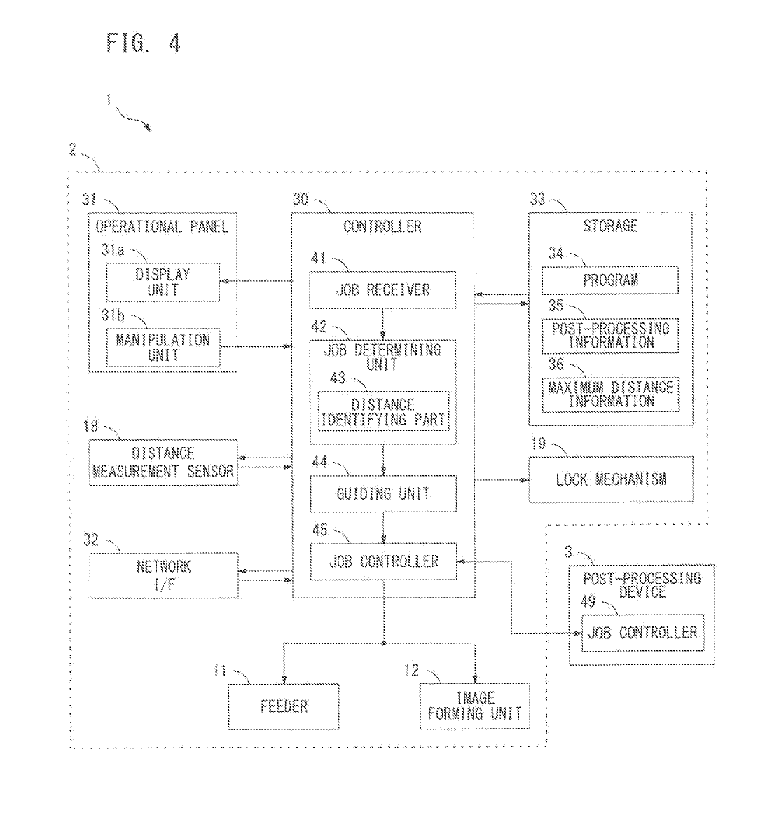

An electrical structure of the image forming device 1 is explained below. FIG. 4 illustrates a block diagram showing an example of the electrical structure of the image forming device 1. The body 2 includes a controller 30, an operational panel 31, a network interface 32 and a storage 33 besides the feeder 11, the image forming unit 12, the distance measurement sensor 18 and the lock mechanism 19 as discussed earlier. The post-processing device 3 includes a job controller 49 to carry out a processing working together with the body 2. The body 2 and the post-processing device 3 are connected to be in communication with each other.

The controller 30 may include a CPU and a memory, for instance. The CPU reads and executes a program 34 in the storage 33 so that the controller 30 serves as a job receiver 41, a job determining unit 42, a guiding unit 44 and a job controller 45. The details of each part are discussed below.

The operational panel 31 is a user interface for a user to operate the image forming device 1. The operational panel 31 includes a display unit 31a and a manipulation unit 31b. A variety of information is displayed to the user on the display unit 31a. The manipulation unit 31b accepts user inputs. The image forming device 1 may configure a variety of settings relating to the print job based on the user inputs to the operational panel 31, and receive the print job specified by the user as an objective of execution.

The network interface 32 connects the image forming device 1 to a network such as a LAN (Local Area Network). Once the network is connected to the network interface 32, the image forming device 1 may receive the print job from an external device (for instance, PC) connected to the network and accept the print job as the objective of execution.

The storage 33 is formed from a non-volatility device such as a hard disk drive, for example. The program 34 executed by the CPU of the controller 30 is stored in advance in the storage 33. Post-processing information 35 and maximum distance information 36 are also stored in the storage 33. The post-processing information 35 is on the post-processing device 3 which is attached to the body 2, and the maximum distance information 36 is on the distance between the post-processing device 3 and the body 2.

Features and/or specifications of the post-processing device 3 are registered as the post-processing information 35. The post-processing information 33 also includes information on the sheet that may be normally passed through the post-processing device 3. With reference to the post-processing information 35. It may be determined the sheet indicated by the print job is supported by the post-processing device 3. In installation of the post-processing device 3 with the body 2, a person such as a service man stores the post-processing information 35 in the storage 33. The users are not free to rewrite the post-processing information 35.

The maximum distance that can detach the post-processing device 3 from the body 2 is stored as the maximum distance information 36. In installation of the post-processing device 3 with the body 2, the person such as the service man stores the maximum distance information 36 in the storage 33, for example. Normally, the distance corresponding to the guide rail 26 is stored as the maximum distance information 36. Depending on the installation site of the image forming device 1, there may be an obstacle such as a desk or a cabinet in the direction of reeling out the post-processing device 3. The distance stored as the maximum distance information 36 is not always the distance corresponding so the length of the guide rail 26. The service man then stores the distance shorter than the distance corresponding to the length of the guide rail 26 and the distance that does not make the post-processing device 3 and the obstacle be in contact as the maximum distance information 36. If the change in the layout of the office is made, the maximum distance that can reel out the post-processing device 3 may also be changed. The maximum distance information 36 can be freely rewritten by the user.

The job receiver 41 receives the print job specified by the user. The job receiver 41 configures the variety of settings based on the user inputs to the operational panel 31, for example, and receives the print job specified by the user as the objective of processing. Upon the receipt of the print job via the network interface 32, the job receiver 41 receives the print job as the objective of execution. Once receiving the print job, the job receiver 41 brings the job determining unit 42 into operation.

The job determining unit 42 determines the sheet type indicated by the print job received by the job receiver 41 can be post-processed by the post-processing device 3. When the print job is received, the job determining unit 42 obtains the information on the sheet type indicated by the print job. With reference to the post-processing information 35, the job determining unit 42 determines the sheet type (size, thickness and/or material of the sheet) indicated by the print job can be passed through the post-processing device 3.

It may be determined the sheet type indicated by the print job cannot be post-processed by the post-processing device 3. The job determining unit 42 then brings a distance identifying part 43. The distance identifying part 43 identifies an interval between the post-processing device 3 and the body 2. The interval that enables the body 2 to process the print job and normally discharge the printing sheet is identified according to the sheet type indicated by the print job. Specifically, the distance identifying part 43 identifies the interval as the minimum distance that enables the body 2 to process the print job and discharge the printing sheet on the upper surface of the post-processing device 3. The size of the sheet may be bigger than the predetermined size, for example. In order to enable the priming sheet discharged by the body 2 to be discharged appropriately on the upper surface of the post-processing device 3, the post-processing device 3 and the body 2 should be detached from each other for more than the predetermined distance. When the sheet size is bigger than the predetermined size, the distance identifying part 43 identifies the predetermined distance as the interval that enables the body 2 to process the print job.

Even when the sheet size is small, the sheet may be hardly bending due to the thickness and/or material. The distance identifying part 43 identifies the predetermined distance as the interval that enables the body 2 to process the print job by considering not only the sheet size but also the difference in ease of bending.

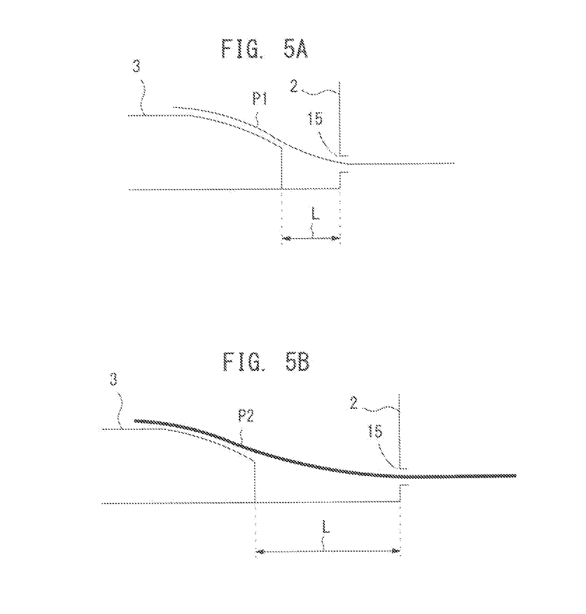

FIGS. 5A and 5B illustrate examples where discharging the easily bendable sheet and the hardly bending sheet. As illustrated in FIG. 5A, the sheet may be an easily bendable sheet P1. Even a distance L1 between the post-processing device 3 and the body 2 is relatively short, the sheet P1 is easily bent with its bendability and normally discharged to the upper surface of the post-processing device 3, led by the guide member. The sheet may be a hardly bending sheet P2. The hardly bending sheet P2 may not be normally discharged to the upper surface of the post-processing device 3 with the same distance for the case of the sheet P1. A paper jam may by occurred inside the discharge port 15. In the case where the sheet is the hardly bending sheet P2, the distance L1 between the post-processing device 3 and the body 2 should be greater than the time of the easily bendable sheet P1 to make sure the hardly bending sheet P2 is normally discharged to the upper surface of the post-processing device 3. The distance identifying part 43 determines the difference in ease of bending based on the thickness and the material of the sheet to identify the minimum distance as the interval that enables the body 2 to process the print job according to the determined difference in ease of bending. The distance identifying part 43 identifies the interval to detach the post-processing device 3 from the body 2 as a flexible value, such as 30 cm, 50 cm or 100 cm, according to the sheet type indicated by the print job.

In the case where site interval that enables the body 2 to process the print job exceeds the maximum distance stored as the maximum distance information 36, the distance identifying part 43 does not identify the interval. The distance identifying part 43 determines that the print job specified by the user cannot be processed.

The sheet type indicated by the print job may be determined as the sheet may not be post-processed by the post-processing device 3. The controller 30 then brings the guiding unit 44 into operation. The guiding unit 44 guides the user to detach the post-processing device 3 from the body 2. The guiding unit 44, for example, shows a message that requesting to detach the post-processing device 3 from the body 2 on the display unit 31a of the operational panel 31, thereby notifying the user. The guiding unit 44 may notify the user of the interval identified by the distance identifying part 43. The user is allowed to know how far he or she should detach the post-processing device 3 from the body 2.

The guiding unit 44 may give the user the variety of guidance information besides the aforementioned guidance. When, for example, the post-processing device 3 is detached from the body 2 upon the start of the job processing, the guiding unit 44 may request the user that the post-processing device 3 should be connected to the body 2, if the distance identifying part 43 determines that the print job cannot be processed, the guiding unit 44 displays the information on the display unit 31 a.

The job controller 45 controls the processing of the print job as the usage forming device 1. The job controller 45 may control the job processing worked together with a job controller 49 of the post-processing device 3. The print job may be processed by the image forming device 1 with the connected post-processing device 3, for example. The job controller 45 then notifies the job controller 49 of the post-processing device 3 of the settings of the post-processing and the timing of discharging the printing sheet discharged by the body 2 so that the printing sheet discharged by the body 2 may be normally received by the post-processing device 3. The post-processing device 3 is then allowed to process the post-processing indicated by the print job.

The controller 45 detects the distance between the body 2 and the post-processing device 3 based on the output of the distance measurement sensor 18. When the distance between the body 2 and the post-processing device 3 does not enable the processing of the print job, the job controller 45 restricts processing of the print job. Once the distance between the body 2 and the post-processing device 3 enables the processing of the print job is detected, the job controller 45 lifts restriction on the job processing and starts processing of the print job.

The job determining unit 42 may determine that the type of the sheet cannot be post-processed by the post-processing device 3 as the post-processing device 3 is connected to the body 2, for example. The job controller 45 then restricts start of the processing of the print job, and monitors the distance between the body 2 and the post-processing device 3 output by the distance measurement sensor 18. Once the distance output by the distance measurement sensor 18 becomes equal to the interval identified by the distance identifying part 43, the job controller 45 brings the lock mechanism 19 into operation to stop sliding of the guide rail 26. The post-processing device 3 is then locked in the position maintaining the distance that enables the processing of the print job. The user is not required to move the post-processing device 3 more than necessary, resulting in lower working load. The job controller 45 then lifts restriction on the job processing and starts processing of the print job. The printing sheet may be discharged by the body 2. The printing sheet discharged by the body 2 is normally discharged to the upper surface of the post-processing device 3.

Upon completion of the processing of the print job, for example, the job controller 45 unlocks the guide rail 26 with the lock mechanism 19. The user is allowed to return the post-processing device 3 to the original position after the printing performed by the image forming device 1.

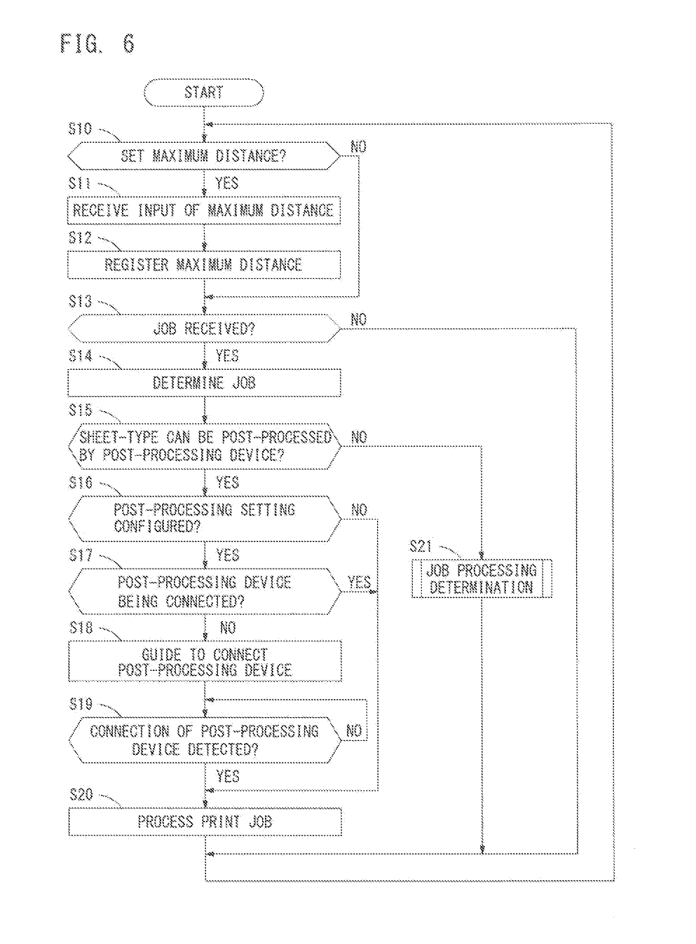

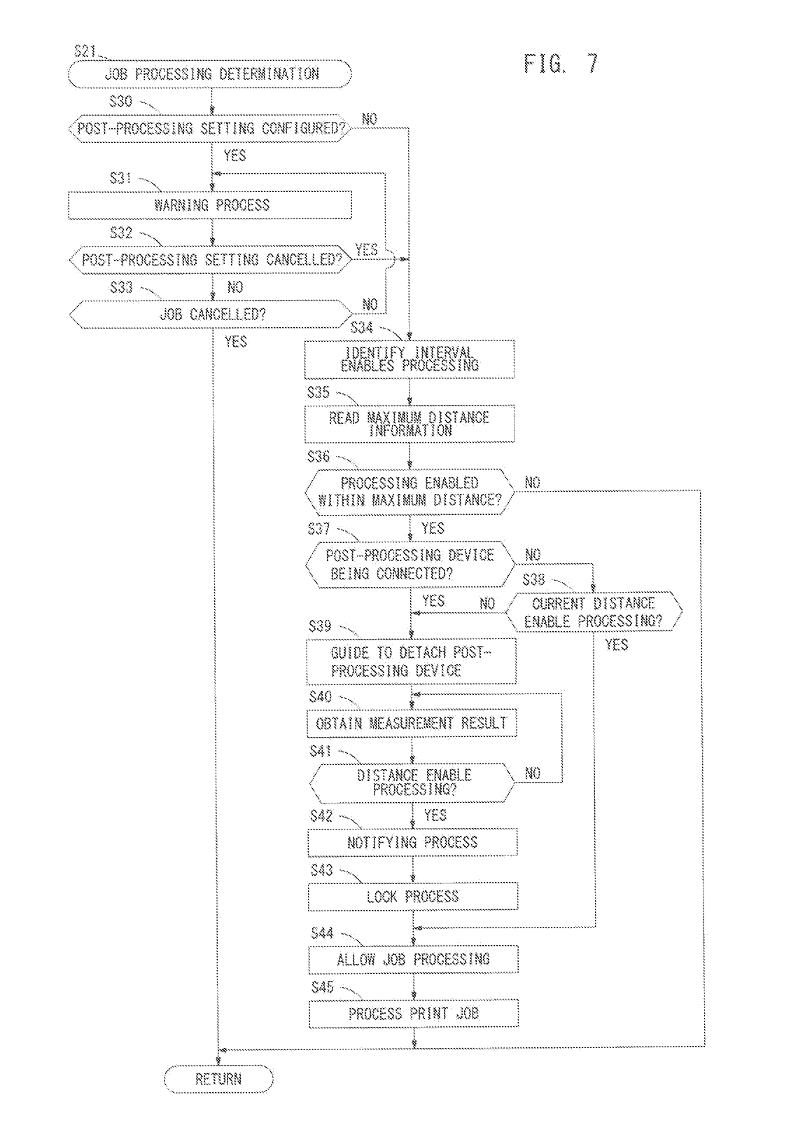

The detailed procedure of a process performed by the image forming device 1 having the above-described structure is explained next. FIGS. 6 and 7 illustrate flow diagrams explaining exemplary procedures of processes performed by the image forming device 1. The CPU of the controller 30 of the body 2 reads and executes the program 34, and the process is performed.

Upon a start of the process, the controller 30 determines whether to set the maximum distance (step S10). An instruction to set the maximum distance may be input by the user who operates the operational panel 31, for example. The controller 30 then determines to set the maximum distance (when a result of step S10 is YES). The controller 30 receives the input to the maximum distance by the user (step S11), and registers the maximum distance based on a value input by the user (step S12). The maximum distance information 36 in the storage 33 is then updated. When updating the maximum distance information 36 in the storage 33, the controller 30 may notify the external device connected to the network via the network interface 32 of the maximum distance. In this case, the controller 30 serves as a notifying part. As the controller 30 serves as the notifying part, the maximum distance may be registered with a printer driver installed on the external device. The controller 30 may then enable the printer driver to restrict the print job that requires longer distance than the maximum distance tor its processing input from the external device. When the maximum distance is not set (when a result of step S10 is NO), the process in steps S11 and S12 is skipped.

The controller 30 determines the print job is received (step S13). When the print job is not received (when a result of step S13 is NO), the controller 30 returns to the process in step S10. In the case where the print job is received (when a result of step S13 is YES), the controller 30 performs the job determination (step S14). Specifically, the controller 30 refers to the post-processing information 35, thereby determining if the sheet type indicated by the print job can be post-processed by the post-processing device 3 (step S15).

The sheet type indicated by the print job can be post-processed (when a result of step S15 is YES). The controller 30 then determines the post-processing setting designating the post processing is configured with the print job (step S16). When the post-processing setting is configured with the print job (when a result of step S16 is YES), the controller 30 further determines the post-processing device 3 is connected to the body 2 (step S17). In the case where the distance output by the distance measurement sensor 18 is 0, for example, it means the post-processing device 3 is connected to the body 2. The controller 30 may determine if the post-processing device 3 is connected to the body 2 based on the distance output by the distance measurement sensor 18.

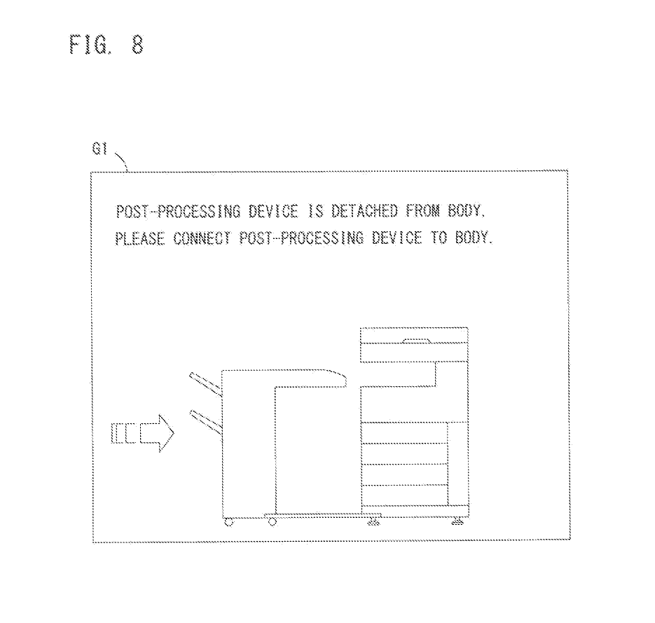

If the post-processing device 3 is not connected to the body 2 (when a result of step S17 is NO), the post-processing device 3 is detached from the body 2. The controller 30 guides the user that the post-processing device 3 should be connected to the body 2 (step S18). The controller 30 may show a guide screen G1 including a message requesting the user to connect the post-processing device 3 to the body 2 as illustrated in FIG. 8 on the display unit 31a or the operational panel 31, thereby performing guidance to the user. The user then may be notified of the necessity that the post-processing device 3 should be connected to the body 2 for the job processing. This guidance may be performed by audio guidance, for instance, except for displaying the screen on the display unit 31a.

The controller 30 then monitors the distance output by the distance measurement sensor 18, and waits until detecting the post-processing device 3 being connected to the body 2 (step S19). After detecting that the post-processing device 3 being connected to the body 2 (when a result of step S19 is YES), the controller 30 starts processing of the print job (step S20).

When the sheet type indicated by the print job can be post-processed (when a result of step S15 is YES), when the post-processing setting is not configured with the print job (when a result of step S16 is NO), or when the post-processing device 3 is connected to the body 2 (when a result of step S17 is YES), the controller starts processing of the print job (step S20).

When the sheet type indicated by the print job cannot be post-processed (when a result of step S15 is NO), the controller 30 performs a job processing determination (step S21).

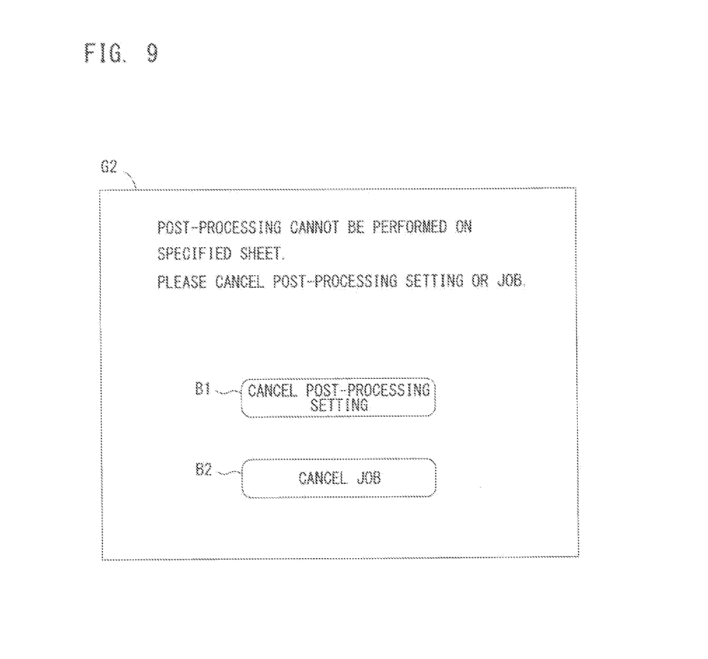

FIG. 7 illustrates a flow diagram explaining an exemplary procedure of the job processing determination (step S21) in detail. Once the job processing determination is started, the controller 30 determines the post-processing setting is configured with the print job as illustrated in FIG. 7 (step S30). The post-processing setting may be configured with the print job (when a result of step S30 is YES). The controller 30 brings the guiding unit 44 into operation to issue a warning to the user (step S31). The controller 30 displays a warning screen G2 including a message indicating that the specified sheet cannot be post-processed on the display unit 31a of the operational panel 31 as illustrated in FIG. 9, for example, thereby issuing the wanting to the user. The warning screen G2 includes a button B1 to cancel the post-processing setting and a button B2 to cancel the print job. Once the warning screen G2 appears, the user selects either button B1 or B2. After the warning process, the controller 30 determines if the input to cancel the post-processing setting is detected (step S32). When the input to cancel the post-processing setting is detected (when a result of step S32 is YES), the controller 30 moves on to the process in step S34. The input to cancel the post-processing setting may not be detected (when a result of step S32 is NO). The controller 30 then determines if the input to cancel the print job is detected (step S33). When the input to cancel the print job is detected (when a result of step S33 is YES), the controller 30 completes the job processing determination. The input to cancel the print job may not be detected (when a result of step S33 is NO). The controller 30 then continues the warning process (step S31).

When the post-processing setting is not configured with the print job (when a result of step S30 is NO), the controller 30 moves on to the process in step S34. The controller 30 brings the distance identifying part 43 into operation to identify the interval between the post-processing device 3 and the body 2 (step S34). The distance to be identified in this step S34 is the distance that enables the body 2 to process the print job using the sheet indicated by the print job. The controller 30 reads the maximum distance information 36, and determines if the print job may be processed by the body 2 with the post-processing device 3 placed within the maximum distance registered as the maximum distance information 36. If the print job may not be processed by the body 2 with the post-processing device 3 placed within the maximum distance (when a result of step S36 is NO), the print job cannot be processed. The controller 30 then completes the job processing determination, in other words, the controller 30 restricts the processing of the print job that cannot be processed within the maximum distance. The warning to the user that the job processing is restricted may be issued.

If the print job may be processed within the maximum distance (when a result of step S36 is YES), the controller 30 determines whether or not the post-processing device 3 is connected to the body 2 (step S37). The post-processing device 3 may be connected to the body 2 (when a result of step S37 is YES). The controller 30 requests the user that the post-processing device 3 should be detached from the body 2 (step S39). The post-processing device 3 may have already been detached from the body 2 (when a result of step S37 is NO), the controller 30 determines the print job can be processed at the current distance (step S38). When the print job can be processed at the current distance (when a result of step S38 is YES), the controller 30 moves on to the process in step S44. When the current distance is shorter than the interval that enables the processing of the print job (when a result of step S38 is NO), the controller 30 requests the user that the post-processing device 3 should be placed farther apart from the body 2 (step S39).

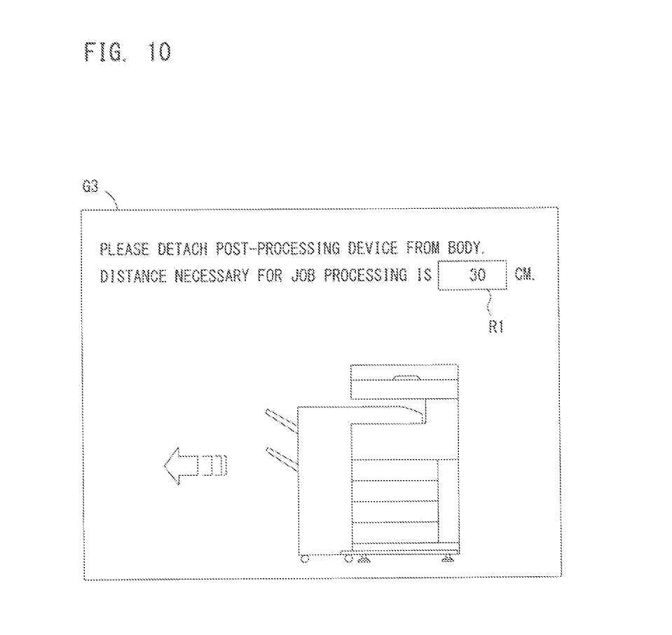

The controller 30 may show a guidance screen G3 including a message requesting the user to move the post-processing device 3 to detach from the body 2 as illustrated in FIG. 10 on the display unit 31a of the operational panel 31, for instance, thereby performing guidance to the user in step S39. The guidance screen G3 includes a distance display field R1 to show the interval that enables the print job processing identified by the distance identifying part 43. The user then may be notified how far the post-processing device 3 should be detached from the body 2 for the job processing. The user is allowed to move the post-processing device 3 immediately. This guidance may be performed by audio guidance, for instance, except for displaying the screen on the display unit 31a.

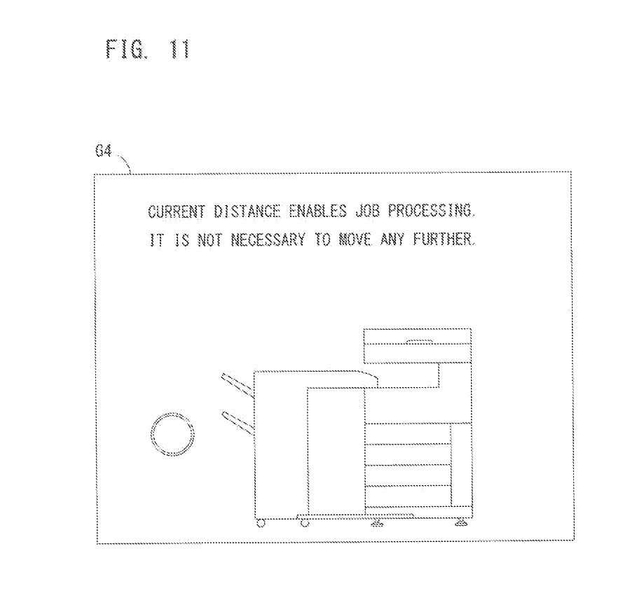

After performing the guidance to detach the post-processing device 3, the controller 30 obtains the measurement result of the distance successively output by the distance measurement sensor 18 (step S40). The controller 30 determines the distance between the post-processing device 3 and the body 2 enables the processing of the print job (step S41). The controller 30 repeatedly performs process in steps S40 and S41 until detecting the distance between the post-processing device 3 and the body 2 enables the processing of the print job. It may be detected that the distance between the post-processing device 3 and the body 2 reaches the one that enables the processing of the print job (when a result of step S41 is YES). The controller 30 then notifies the user (step S42). In this process, the user is notified that the print job may be processed with the body 2. The controller 30 may show a notification screen G4 including a message notifying the user that the current distance enables the job processing as illustrated in FIG. 11 on the display unit 31a of the operational panel 31, for instance, thereby notifying the user. The user may finish moving the post-processing-device 3. This notification may be performed by audio, for instance, except for displaying the screen on the display unit 31a.

Once detecting the current distance enables the job processing, the controller 30 brings the lock mechanism 19 into operation to stop sliding the guide rail 26 (step S43). The post-processing device 3 is locked at the position that enables the processing of the print job and is not moved any farther. Even if the operator is not noticed of being notified, for example, he or she may recognize the current distance enables the processing of the print job as the post-processing device 3 is locked.

The controller 30 allows the processing of the print job (step S44), and enables the body 2 to start the processing of the print job (step S45). The job processing determination is thus complete.

The image forming device 1 of the present preferred embodiment determines if the sheet type indicated by the print job may be post-processed by the post-processing device 3. The sheet type indicated by the print job may not be post-processed by the post-processing device 3 The image forming device 1 then guides the user to detach the post-processing device 3 from the body 2, and detects the distance between the post-processing device 3 and the body 2. Once the image forming device 1 detects the detected distance becomes greater than the interval that enables the processing of the print job, it allows the processing of the print job. More specifically, the print job may be processed using the printing sheet not supported by the post-processing device 3. The image forming device 1 of the present preferred embodiment then allows the processing of the print job once it determines the detected distance reaches the interval that enables the body 2 to discharge the printing sheet normally. Hence, the user is not required to detach the post-processing device 3 to the maximum every time, resulting in lower operation load.

For guiding the user to detach the post-processing device 3 from the body 2, the image forming device 1 of the present preferred embodiment notifies the user of the distance that enables the processing of the print job. The user may be notified in advance that he or she should not detach the post-processing device 3 to the maximum when he or she detaches the post-processing device 3 from the body 2.

The image forming device 1 of the present preferred embodiment stores the maximum distance that may detach the post-processing device 3 from the body 2. The image forming device 1 restricts the processing of the print job that requires the distance for processing of the print job exceeds the maximum distance. Occurrence of an error such as a paper jam during the processing of the print job may be prevented in advance. The maximum distance is configurable for the user. Even when there is the obstacle in the direction of moving the post-processing device 3, the maximum distance within the distance that the post-processing device 3 does not get in contact with the obstacle may be configured with the image forming device 1.

As described above, the printing may be normally performed using the sheet not supported by the post-processing device 3 with a lower operation load on the user.

While the preferred, embodiment of the present invention has been described above, the present invention is not limited to the preferred embodiment. Various modifications may be applied to the present invention.

In the above-described present preferred embodiment, for example, the body 2 may be used for both the general office works and the professional-quality printings and the post-processing device 3 may only be used for the general office works. However, this is given not for limitation. The specifications of the body 2 and the post-processing device 3 are not always limited for the aforementioned uses. The present invention may broadly be applied to cases where the sheet normally fed by the body 2 cannot be fed by the post-processing device 3.

In the above-described present preferred embodiment, for example, the screens such as the guide screen and the warning screen are displayed on the display unit 31a of the operational panel 31. The image forming device 1 may receive the print job from the external device over the network. The user may be distant from the image forming device 1 in such a case, and he or she cannot see the screen displayed on the display unit 31a. It may be necessary to detach the post-processing device 3 for the processing of the print job or it may be necessary to cancel the post-processing setting of the print job when the print job is received from the external device over the network. In such a case, the image forming device 1 may send the guide screen and/or the warning screen to the external device to enable the external device to display the screen. The guide screen and/or the warning screen displayed on the external device enables the user who input the print job to notify that he or she should detach the post-processing device 3 or he or she should cancel the post-processing setting or the print job. This guidance or warning does not have to be preformed on the external device by the displayed screen. The guidance or warning may be performed by audio, for instance.

After processing the print job with the post-processing device 3 detached from the body 2, the image forming device 1 may guide the user to return the post-processing device 3 to the position connected to the body 2. The user who input the print job thereby processed then does not leave from the image forming device 1 without returning the post-processing device 3 to the original position connected to the body 2 after the print job is processed by the image forming device 1. Thus reduces the operation load on the next user when he or she uses the post-processing device 3 to process the print job.

Although the embodiment of the present invention has been described and illustrated in detail, the disclosed embodiments are made for purposes of illustration and example only and not limitation. The scope of the present invention should be interpreted by terms of the appended claims.

What is claimed is:

1. An image forming device, comprising:
a body that processes a print job and discharges a printing sheet;
a post-processing device, which may be connected or detached from said body, capable of receiving the printing sheet discharged by said body when being connected to said body and performing a post-processing; and
a hardware processor, wherein
the hardware processor performs:
determining whether or not a sheet type indicated by said print job may be post-processed by said post-processing device;
guiding a user to detach said post-processing device from said body when the sheet type indicated by said print job may not be post-processed by said post-processing device;
detecting a distance between said post-processing device and said body when said post-processing device is detached from said body; and
allowing a processing of said print job when the detected distance is greater than an interval that enables the processing of said print job if the sheet type indicated by said print job may not be post-processed by said post-processing device.

2. The image forming device according to claim 1, wherein
the hardware processor identifies the interval that enables the processing of said print job is accordance with the sheet type indicated by said print job.

3. The image forming device according to claim 1, wherein
the sheet type includes sheet size.

4. The image forming device according to claim 1, wherein
the hardware processor guides the interval that enables the processing of said print job to the user.

5. The image forming device according to claim 1, wherein
the hardware processor guides the user to cancel a setting of post-processing configured with said print job when the sheet type indicated by said print job may not be post-processed by said post-processing device and the setting of the post-processing is configured with said print jots, and
allows the processing of said print job when the setting of post-processing configured with said print job is canceled.

6. The image forming device according to claim 1, further comprising:
a lock mechanism that locks the distance between said post-processing device and said body when the detected distance greater than the interval that enables the processing of said print job is detected.

7. The image forming device according to claim 1, wherein
the hardware processor notifies the user that the detected distance is greater than the interval that enables the processing of said print job.

8. The image forming device according to claim 1, further comprising:
a storage that stores a maximum distance capable of detaching said post-processing device from said body, wherein.
the hardware processor restricts the processing of said print job when the interval that enables the processing of said print job exceeds said maximum distance.

9. The image forming device according to claim 8, wherein
the hardware processor further notifies an external device of said maximum distance, thereby restricting input of the print job, the processing of which requires the interval exceeding said maximum distance, from said external device.

10. A non-transitory recording medium storing a computer readable program, execution of the computer readable program by an image forming device comprising:
a body that processes a print job and discharges a printing sheet; and
a post-processing device, which may be connected or detached from said body, capable of receiving the printing sheet discharged by said body when being connected to said body and performing a post-processing,
the program causing said image forming device to perform;
determining whether or not a sheet type indicated by said print job may be post-processed by said post-processing device;
guiding a user to detach said post-processing device from said body when the sheet type indicated by said print job may not be post-processed by said post-processing device;
detecting a distance between said post-processing device and said body when said post-processing device is detached from said body; and
allowing a processing of said print job when the detected distance is greater than an interval that enables the processing of said print job if the sheet type indicated by said print job may not be post-processed by said post-processing device.

11. The non-transitory recording medium according to claim 10, wherein
the interval that enables the processing of said print job is identified in accordance with the sheet type indicated by said print job.

12. The non-transitory recording medium according to claim 10, wherein
the sheet type includes sheet size.

13. The non-transitory-recording medium according to claim 10 wherein
the interval that enables the processing of said print job is guided to the user.

14. The non-transitory recording medium according to claim 10, wherein execution of the computer readable program by said image forming device causing said image forming device to further perform:
guiding the user to cancel a setting of post-processing configured with said print job when the sheet type indicated by said print job may not be post-processed by said post-processing device and the setting of the post-processing is configured with said print job, and
allowing the processing of said print job when the setting of post-processing configured with said print job is canceled.

15. The non-transitory recording medium according to claim 10 wherein execution of the computer readable program by said image forming device causing said image forming device to further perform;
controlling movement of said post-processing device and locking the distance between said post-processing device and said body when the detected distance greater than the interval that enables the processing of said print job is defected.

16. The non-transitory recording medium according to claim 10, wherein
notifying the user that the detected distance is greater than the interval that enables the processing of said print job.

17. The non-transitory recording medium according to claim 10, wherein execution of the computer readable program by said image forming device causing said image forming device to further perform:
enabling a storage to store a maximum distance capable of detaching said post-processing device from said body, and
restricting the processing of said print job when the interval that enables the processing of said print job exceeds said maximum distance.

18. The non-transitory recording medium according to claim 17, wherein execution of the computer readable program by said image forming device causing said image forming device its further perform:
notifying an external device of said maximum distance, thereby restricting input of the print job, the processing of which requires the interval exceeding said maximum distance, from said external device.
